(19) United States
(12) Patent Application Publication
(10) Pub. No.: US 2013/0108751 A1
(43) Pub. Date: May 2, 2013

(54) Method and Equipment for Producing Oxidation-Sensitive Liquids Implementing the Injection of Hydrogen Immediately Prior to Pasteurization

(71) Applicants: Philippe Campo, Montigny Le Bretonneux (FR); Dominique Ibarra, Gif-Sur-Yvette (FR)

(72) Inventors: Philippe Campo, Montigny Le Bretonneux (FR); Dominique Ibarra, Gif-Sur-Yvette (FR)

(21) Appl. No.: 13/806,672

(22) PCT Filed: Jun. 24, 2011
(86) PCT No.: PCT/EP11/60636

§ 371 Date: Dec. 21, 2012

(30) Foreign Application Priority Data
Jul. 1, 2010 (FR) 1055275

(51) Int. Cl. A23L 3/3409

(52) U.S. Cl. CPC A23L 3/3409
USPC 426/313; 99/483

(57) ABSTRACT

The invention relates to a method for producing a liquid or semi-liquid product that is sensitive to oxidation, for example beverages, wherein the production method includes a step of deoxygenating an intermediate medium involved in the production of either the liquid or the semi-liquid, and a heating step, for example pasteurization, after the deoxygenation step, characterized in that the method involves injecting a hydrogenated gaseous mixture into the liquid or semi-liquid between the deoxygenation step and the heating step.

The present invention relates to the field of processes for producing oxidation-sensitive liquid or semi-liquid products, and for which the manufacturing process has a heating step, for example a pasteurization, this is the case, for example, for certain food products such as still or carbonated beverages, fruit juices, flavored waters, compotes or jams, or else dairy products, especially certain cheeses, etc.

Let us consider in what follows the example of beverages, specifically these beverages see their quality deteriorate, on the one hand during the manufacturing process (especially during a pasteurization step), and on the other hand during their subsequent preservation. This phenomenon can impair both the sensory quality (taste, smell, color, etc.) and the nutritional quality (the vitamin content in particular) of these products. The shelf life of the products is of course adversely affected thereby.

By way of illustration, it is known from numerous studies that beverages flavored with citrus fruits, and especially with lemon, are very sensitive to oxidation. Other studies have focused on the effect of pasteurization on an orange juice and have especially shown that the loss of limonene, which often represents more than 93% of all of the aroma compounds of the concentrate used, amounts to almost 16%. It is partly due to the oxidation of this molecule which leads to the increase of limonene oxides: α-terpineol, nerol and geraniol in particular.

Moreover, among the colorants used in this sector, β-carotene (yellow-orange, E 160a) and paprika extracts (orange-red, E 160c) are also sensitive to oxidation. Likewise, beetroot red (pink-red, E 162) has a limited stability in the presence of oxygen, hence the difficulties encountered by manufacturers in preserving their beverages containing red fruits, the color of which gradually turns brown during the storage thereof at ambient temperature. This problem is even more pronounced when the manufacturer wishes, in order to meet the expectations of the consumer, not to use preservatives. It is important to note that the color is the first product characteristic that the consumer sees on the shelf, that is to say an important, sometimes even decisive, purchase factor.

In the event of the presence of oxygen, the oxidation may be rapid in the treatment steps where the product is heated, in particular in an optional pasteurization step. The oxidation is obviously slower when the product is at ambient temperature, in particular during its storage period. Some factors may however contribute to a faster degradation/oxidation during this period, in particular the exposure of the product to light, the diffusion of oxygen through the packaging, etc.

Oxidation is frequently attributed to the oxygen permeability of plastic packagings. Indeed, irrespective of the quality of the inerting during bottling (residual amount of oxygen in the headspace of the packaging), the residual dissolved oxygen contained in the product during the packaging thereof and the diffusion over time of oxygen through the packaging mean that it is difficult, or even impossible, for certain containers to completely eliminate the risk of oxidation over time. However, it is possible to at least partially delay the oxidation. Indeed, a predominant portion of the oxidation is based on radical reactions, radicals produced inter alia by dissolved oxygen, light and organic initiator and propagator compounds.

Limiting the latter compounds makes it possible to limit the oxidation, in particular during the product storage period. It is therefore essential that the oxidation process cannot begin at the step of producing the beverage or one of its ingredients.

The literature has revealed that the oxidation mechanisms take place according to three distinct phases:

1—Initiation:

The initial reaction mechanism consists of the formation of a free radical by pulling off a hydrogen atom.

RH→R.+H.

The oxidation is firstly very slow due to the low initiation rate. Indeed, the departure of the hydrogen atom is not very likely due to the high activation energy of the reaction. It is however facilitated by heating, light or metal ions.

2—Propagation:

In the presence of oxygen, the R. free radical reacts in order to result in the formation of a peroxyl radical ROO.. The latter stabilizes its structure by pulling off a hydrogen atom from another molecule R′H. The free radical R′. thus formed is highly reactive and may continue the reaction according to the same principle (loop reactions).

R.+O₂→ROO.

ROO.+R′H→ROOH+R′.

3—Termination:

When the concentration of free radicals becomes high enough, the latter combine in order to stop the propagation chain.

R.+R′OO.→ROOR′

R.+R′.→RR′

2ROO.→ROOR+O₂

Molecules known as “antioxidants” (AH₂), that is to say that have a redox potential lower than that of the free radicals, may also stop the oxidation. Thus, for example, amines, phenols, sulfide derivatives and certain polycondensed aromatic hydrocarbons are weak inhibitors of oxidation reactions.

R.+AH₂→RH+AH.

ROO+AH₂→ROOH+AH.

It is then understood that this industrial sector is constantly seeking processes that make it possible to limit the oxidation of these products, in order to extend their best-before date and thus reduce the costs for the manufacturer.

In addition, it is also understood that one of the means identified for fighting the oxidation of sensitive liquids is to delay or limit the initiation phase. For this, it is necessary to act before the heating step, in order to reduce the production of R. and ROO. free radicals, which are the precursors or initiators of the oxidative chain reactions which will deteriorate the product during the propagation phase.

This industry has proposed various technical solutions, among which mention may be made of the following approaches:

I) The Use of Antioxidants

The main antioxidants used in food products are:
ascorbic acid and its sodium and calcium salts and also its ascorbyl palmitate and ascorbyl stearate esters (E 300 to E 304ii),
tocopherols (E 306 to E 309),
esters of gallic acid: propyl, octyl and dodedyl gallate (E 310 to E 312),
butylhydroxyanisole (BHA, E 320),
butylhydroxytoluene (BHT, E 321).

The use of antioxidants is however subject to regulatory constraints (restriction of use, dose to be complied with). Thus, for example, in fruit juices and nectars, only the following antioxidants are authorized: E 300 and E 301 according to the Parliament and Council Directive 95/2/EC. BHA and BHT are themselves used, for example, as antioxidants in the solutions of flavorings that are incorporated into the composition of beverages.

The use of additives has several drawbacks, among which the legal obligation to include the list thereof on the labeling of the finished product. Furthermore, additives in general, and therefore antioxidants, are very often, due to their nomenclature (E XXX), likened to “chemicals” that are “not natural” by consumers. Furthermore, not only do they convey a negative image, but they are not always sensorially neutral.

Certain additives may give rise to physiological disorders (BHA and BHT in particular), and it is then advisable to adapt their dosage in order to comply with the acceptable daily intake defined in the legislation. This constraint can limit their effectiveness.

Furthermore, ascorbic acid, erythorbic acid and ascorbyl palmitate are not very heat-stable whilst gallates are heat-sensitive.

Finally, the mechanisms of action of antioxidants have an effectiveness which remains however limited since they are very easily oxidizable molecules (low reducing power).

J) Deoxygenation: Under Vacuum or Under Gas (Degassing)

Deoxygenation is one way of fighting the oxidation phenomena and thus increasing the storage life of a product. This step of deoxygenation (or degassing) may be carried out either by a process based on placing the product under complete or partial vacuum, or by a gaseous entrainment of the dissolved oxygen by injection of an inert gas, process commonly known as “stripping”.

By way of example, mention may be made of patent U.S. Pat. No. 2,151,644, which proposes a method for deaerating a liquid food product by continuously circulating a liquid in film form in a vacuum chamber. Similarly, document WO 2005/004643 proposed a continuous deaeration of lemon juice at low temperature (˜0° C. to 10° C.) and under vacuum.

Document WO 2006/039674 itself claims the use of porous-type injectors in order to introduce nitrogen in the form of small bubbles at various points of the production line in order to reduce the amount of oxygen dissolved in lemon juice.

The deoxygenation technologies, whether they use vacuum or an inert gas such as nitrogen, make do with partly expelling the oxygen present in the liquid. Thus, they make it possible, for example, to limit the aerobic degradation pathway of vitamin C and the appearance of browning in an orange juice. However there still remains residual oxygen, or even optionally oxidizing agents comprising oxygen combined, in particular of nitrate and sulfate type, capable of reacting in order to oxidize the sensitive molecules. In that regard, this solution is not therefore completely satisfactory.

K) Deoxygenation with a Gas Mixture Containing Hydrogen

The applicant proposed in document FR 2 811 292 a process for packaging perishable products comprising, in particular, the possibility of introducing into a liquid product a protective gas comprising a certain amount of hydrogen, the balance being formed by one or more packaging gases. It will have been understood that this prior process is therefore only interested in the packaging stage, that is to say after the pasteurization step. It therefore makes it possible to protect the liquid during the storage thereof, but it does not make it possible to protect it from the oxidation that is initiated during the pasteurization.

Other studies have investigated, on the laboratory scale (150 mL), the impact of nitrogen or nitrogen-hydrogen (96% N₂, 4% H₂) bubbling before pasteurization on the microbiological quality, the color and the content of ascorbic acid of an orange juice, and showed that a deoxygenation, with nitrogen or nitrogen-hydrogen, leads to a loss of effectiveness of the pasteurization (less microorganisms killed) compared to the same process without prior deoxygenation. Furthermore, after seven weeks of storage, the authors observe that the fact of deoxygenating before pasteurization has improved the stability of ascorbic acid and that of the color compared to the absence of prior deoxygenation. However, they do not observe a significant difference between a deoxygenation using nitrogen and a deoxygenation using nitrogen-hydrogen. At the end of this study, the authors therefore recommend introducing the gas into the liquid just after pasteurization so as to maximize the destruction of the microorganisms while stabilizing the product during its storage.

As will be seen in greater detail in what follows, the present invention proposes a novel process for manufacturing a liquid or semi-liquid product such as those targeted above, undergoing a heating step, in particular a pasteurization step, that makes it possible to limit the formation of compounds that may act as radical initiators and/or propagators in the oxidation reactions during the storage period of the products, and thus that makes it possible to increase their storage life.

The novel approach of the invention is based on the fact that it does not make do, as proposed by the prior art, with deoxygenating the product before pasteurization, it proposes to combine a step of deoxygenation, irrespective of the process used (vacuum, purging with an inert gas, with a gas mixture containing hydrogen, etc.), with the injection of a hydrogen-containing gas mixture between the deoxygenation step and the heating step, preferably just before the heating step, and as will be seen this amount may be minimal. This injection makes it possible to use the reducing nature of the hydrogen in an optimal manner, due to being under very favorable conditions, since the hydrogen injected will be able to act immediately afterward (during the heating) at a temperature above ambient temperature.

The present invention then relates to a process for producing an oxidation-sensitive liquid or semi-liquid product, which production process comprises a step of deoxygenation of an intermediate medium that occurs in the manufacture or else of the liquid or semi-liquid itself, and which comprises a heating step, for example a pasteurization, subsequent to the deoxygenation step, being characterized in that, between the deoxygenation step and the heating step, a hydrogen-containing gas mix is injected into the liquid or semi-liquid.

It will have been understood that, in most cases, the deoxygenation takes place in the liquid or semi-liquid medium itself (the pure juice, or else the already flavored water, the compote, etc.) but it may also happen that the deoxygenation step takes place in an intermediate medium that occurs in the manufacture. By way of example, in the case of a fruit juice based on concentrate, it can be envisaged to deoxygenate the water alone first, then add the concentrate, before carrying out the injection of gas according to the invention.

According to advantageous embodiments of the invention, the invention will be able to adopt one or more of the following technical features:
the hydrogen-containing gas mix is pure hydrogen;
the hydrogen-containing gas mix is a mixture of nitrogen and hydrogen, the hydrogen content of which is between 1% and 100%, but preferably lying between 50% and 100%;
the deoxygenation step of the intermediate or liquid or semi-liquid medium is carried out by placing the intermediate medium or the liquid or semi-liquid in question under complete or partial vacuum;
the deoxygenation step is carried out by injection of an inert gas or of a gas mixture comprising a reducing gas such as hydrogen into the liquid medium or the liquid or semi-liquid in question;
the injection of the hydrogen-containing gas mixture between the deoxygenation step and the heating step is carried out just before the heating step, typically by taking into account the time needed for the transfer of the hydrogen into the liquid phase, and therefore preferably from 5 s to 30 s before the heating step.

The present invention also relates to a plant for producing an oxidation-sensitive liquid or semi-liquid product, which plant comprises a device for the deoxygenation of an intermediate medium that occurs in the manufacture or else of the liquid or semi-liquid itself, and also a device for heating this liquid or semi-liquid, located downstream of the deoxygenation device, being characterized in that it comprises a device for injecting a hydrogen-containing gas mix into the liquid or semi-liquid, located between the deoxygenation device and the heating device.

According to one of the embodiments of the invention, the device for injecting the hydrogen-containing gas may be the same as the deoxygenation device when the deoxygenation is carried out by injecting an inert or non-inert gas such as a hydrogen-containing gas (loop operation).

Other features and advantages of the present invention will appear more clearly in the following description, given by way of illustration but in no way limitingly, and made in connection with the appended figures where:

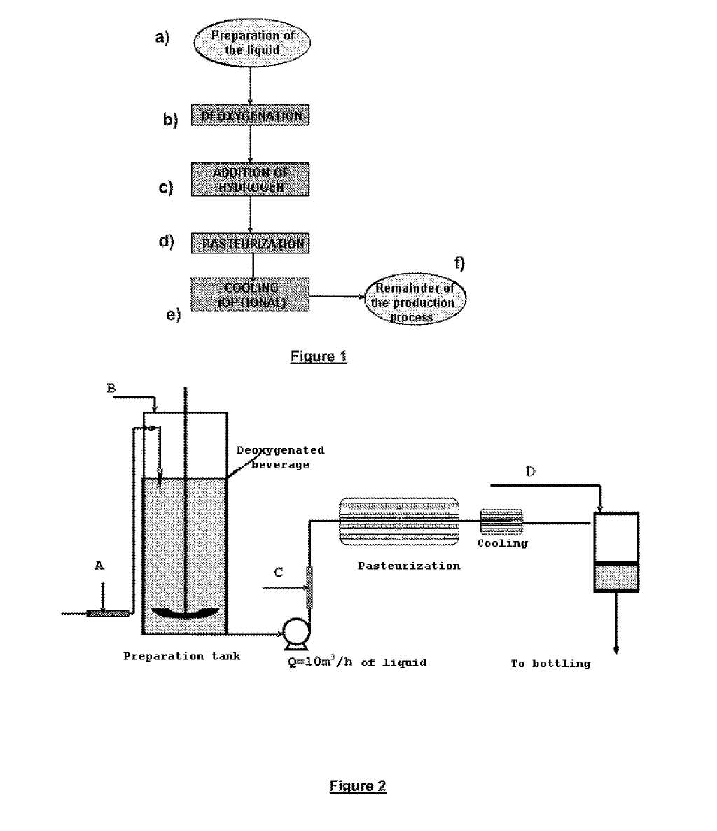

FIG. 1 is a simplified diagram that makes it possible to visualize the locations where the invention takes place;

FIG. 2 is a partial schematic representation of a plant for manufacturing and bottling beverages in accordance with the invention, having enabled the implementation of exemplary embodiments;

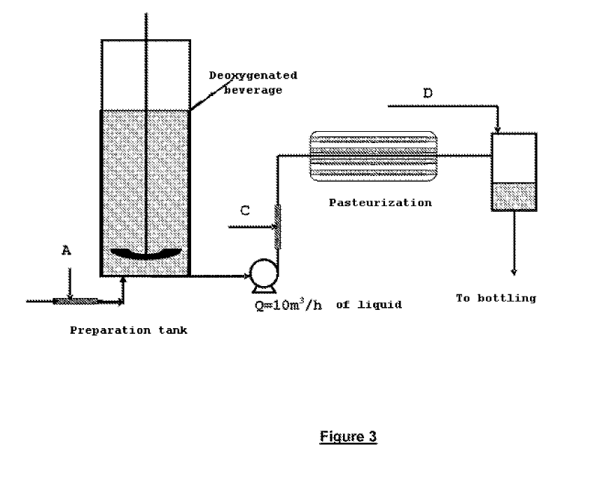

FIG. 3 is a variant of the plant from FIG. 2, which does not use cooling after pasteurization, and that combines the injections A and B from FIG. 2 in a single injection.

The following steps are recognized in FIG. 1:
step a) of “liquid preparation”, which is a step of reconstituting the liquid, for example the production of the mixture of water, juice concentrate and pulp, or else the production of a mixture of water+various flavoring ingredients in the case of a flavored water, but it is understood that this preparation step may be nonexistent in certain cases or else reduced to the minimum by the fact that the liquid is already completely ready (for example what is referred to as a “pure juice”);
step b) which is a deoxygenation step, for example via injection of an inert gas into the liquid. It should be noted that in order to carry out the deoxygenation, the injection alone of nitrogen or of another gas is not sufficient, as is known, the liquid will have to pass, later on in the production line, into equipment that enables the oxygen-laden gas to come out of the liquid and the line.

As has been said, this deoxygenation may be carried out by vacuum but a gas purging will be preferred, on the one hand to prevent the subsequent “collapsing” of the packaging, and on the other hand to reduce the loss of aroma compounds at this step. Without forgetting the fact that the gaseous method is less energy-consuming and requires a lower equipment investment.

An addition of ingredients may optionally take place after this deoxygenation. Thus, for example in the case of a concentrate-based fruit juice, it can be envisaged to deoxygenate the water then add the concentrate after step b) and before step c). In this case, it is possible to carry out the sequence b) then c) (then b) again if necessary) then d), etc.

This introduction of an inert gas into the liquid makes it possible to shift the oxygen from the liquid phase to the gas phase. This deoxygenation may take place in the tank, the headspace of which is inerted, or else in line in equipment well known to a person skilled in the art.
step c) which consists in injecting a hydrogen-containing mixture, here pure hydrogen, into the liquid;
step d) of pasteurization;
very often, there is a step e) of cooling the product downstream of the heating step and before the packaging of the product, but this cooling is only optional;
the liquid resulting from the pasteurization (or from the cooling) then being sent toward the downstream of the line (f)), that is to say toward the next steps of the production of this liquid, for example a bottling of the beverage.

As is understood, it is highly preferable, downstream of the deoxygenation step b) to ensure that all the tanks and other equipment into which the liquid passes are carefully inerted, including the equipment used downstream of the pasteurization, and especially the final packaging f).

As indicated above, the amount of hydrogen added just before pasteurization may be minute.

When the curve (much referenced in the literature) which represents the solubility of hydrogen in water at atmospheric pressure as a function of temperature is considered, it is observed for example that this solubility is of the order of 1.6 mg/l at 20° C. under around 1 bar. Still referring to the curves from the literature at different pressures, it is of the order of 4.8 mg/l at 20° C. under around 3 bar.

FIG. 2 is a partial schematic representation of a plant for manufacturing and bottling beverages that enables the implementation of the invention.

This beverage production line enables the bottling of an hourly throughput of 10 m³/h of liquid.

Found in this FIG. 2 are of course the essential elements of the schematic representation of FIG. 1, and in particular:
the tank for preparing the beverage or for storing a pure fruit juice for example, this tank undergoing here two injections of nitrogen: injection A into the liquid, intended to move oxygen from the liquid phase to the gas phase, and injection B, into the top of the tank, which serves to inert the tank (these two injections may where appropriate be combined, see FIG. 3);
the injection in line (C) into the liquid, just upstream of the pasteurization device, of a flow rate of 0.18 Nm²/h of pure hydrogen, this injection will be carried out, for example, by means of a porous-type injector, of a static mixer, or else Venturi, or any other equivalent equipment.

The injector is therefore positioned on the line upstream of the pasteurization heat exchanger, preferably by leaving a contact time after injection of between 5 and 30 s.

The amount of hydrogen injected will preferably be between the saturation value at ambient temperature under one atmosphere and the saturation value under the same temperature conditions at the pressure of the beverage line.

For the exemplary embodiment from FIG. 2, which is a production line under 3 bar, the amount injected is preferably between 16 and 48 g/h of hydrogen, i.e. between 0.18 and 0.54 Nm³/h of pure hydrogen.
downstream of the pasteurization equipment and after cooling of the product an inerted buffer tank (injection D) is positioned, this tank may be inerted in static mode (without renewal of the overhead), or in purging mode (renewed, which is preferred). In the latter case and in order to eliminate any risk of excessive concentration of hydrogen in the atmosphere, it is preferable to purge the headspace of the buffer tank with an inert gas, for example nitrogen at a minimum flow rate so that the hydrogen concentration in the gas phase is under any circumstances less than 4%, thus, as is known, eliminating any related risk.

For the exemplary embodiment for this FIG. 2, put in place at D is a purging flow rate of the overhead by an inert gas at a minimum flow rate of QN₂=0.18/0.04=4.5 Nm³/h, i.e. around 0.5 Nm³ of nitrogen per cubic meter of beverage produced.

The measurements carried out on the fruit juices thus produced, after all of the steps and after three days of storage show a residual hydrogen level equal to 25% of the saturation in glass bottles at 20° C., and equal to 4% in PET bottles.

Every advantage that there is in carrying out an injection of hydrogen or of a hydrogen-containing mixture at the location where it is envisaged according to the invention is then understood since in this way:
it takes place at a location where the liquid is already deoxygenated;
it does not take place too early in the process, at the risk that the hydrogen is eliminated at the time of the degassing and with the unfavorable consequence that the hydrogen will no longer be present at the time of the heating;
it does not take place too late in the process, for example after the pasteurization, since, and this is the very inventive measure of the present invention, it is desired for the dissolved hydrogen to be present during this pasteurization step in order to prevent the formation of oxidation precursors during the heating.

Other advantages of the process of the invention compared to the prior solutions may be summarized in what follows:
It is easily adapted to the existing line.
It does not represent a sizable investment.
It does not make do with expelling oxygen.
It does not have sensory or legal constraints, nor an impact on human physiology.
It benefits from the highly reducing power of hydrogen (compared to the antioxidants used customarily), without having to add mineral and/or organic additives.
It does not increase the labeling (list of ingredients).
It does not lead to additional flavor losses.

1-7. (canceled)

8. A process for producing an oxidation-sensitive liquid or semi-liquid product, which production process comprises a step of deoxygenation of an intermediate medium that occurs in the manufacturing of the liquid or semi-liquid itself, and which comprises a heating step, for example a pasteurization, subsequent to the deoxygenation step, wherein, between the deoxygenation step and the heating step, a hydrogen-containing gas mix is injected into the liquid or semi-liquid.

9. The process for producing an oxidation-sensitive liquid or semi-liquid product of claim 8, wherein the hydrogen-containing gas mix is pure hydrogen.

10. The process for producing an oxidation-sensitive liquid or semi-liquid product of claim 8, wherein the hydrogen-containing gas mix is a mixture of nitrogen and hydrogen, the hydrogen content of which is between 1% and 100%, preferably between 50% and 100%.

11. The process for producing an oxidation-sensitive liquid or semi-liquid product of claim 8, wherein the deoxygenation step is carried out by placing under complete or partial vacuum.

12. The process for producing an oxidation-sensitive liquid or semi-liquid product of claim 8, wherein the deoxygenation step is carried out by injection of an inert gas or of a gas mixture comprising a reducing gas such as hydrogen.

13. The process for producing an oxidation-sensitive liquid or semi-liquid product of claim 8, wherein the injection of the hydrogen-containing gas mixture between the deoxygenation step and the heating step is carried out just before the heating step, preferably from 5 s to 30 s before the heating step.

14. A plant for producing an oxidation-sensitive liquid or semi-liquid product, which plant comprises a device for the deoxygenation of an intermediate medium that occurs in the manufacture or else of the liquid or semi-liquid itself, and also a device for heating the liquid or semi-liquid, located downstream of the deoxygenation device, being characterized in that it comprises a device for injecting a hydrogen-containing gas mix into the liquid or semi-liquid, located between the deoxygenation device and the heating device.
